(19) United States
(12) Patent Application Publication
(10) Pub. No.: US 2014/0379357 A1
(43) Pub. Date: Dec. 25, 2014

(54) Staff Assignment and Sharing System

(71) Applicant: Rauland-Borg Corporation, Mt. Prospect, IL (US)

(72) Inventors: Karthik Srivathsa, Schaumburg, IL (US); Bin Yang, Lisle, IL (US); Jennifer A. Holden, Mundelein, IL (US)

(21) Appl. No.: 13/924,170

(22) Filed: Jun. 21, 2013

(51) Int. Cl. G06F 19/00

(52) U.S. Cl. CPC G06F 19/327
USPC 705/2

(57) ABSTRACT

A system, method, and device are provided for sharing staff assignments between a nurse call system in a hospital and other hospital systems possessing assignments interfaces. Sharing is achieved by an assignment server working in conjunction with a nurse call system of the hospital. The assignment server contains an assignment interface that exchanges staff assignments with interface devices and the nurse call system. The assignment server is further capable of updating and synchronizing staff assignments between the interface devices and the nurse call system. Interface devices can be assigned to staff, staff can be assigned to locations within the hospital, and interface devices can be assigned to locations within the hospital by accessing a publishing system and updating staff assignments within the nurse call system. Accordingly, redundancy of a staff member updating each various interface device a staff member utilizes is reduced.

### FIELD OF THE INVENTION

This invention generally relates to hospital staff assignment and nurse call systems, and more particularly to staff assignment and sharing of staff assignments between a nurse call system and devices that interface with the nurse call system.

### BACKGROUND OF THE INVENTION

A typical hospital includes many care units, such as an Intensive Care Unit (ICU), a Cardiology Unit, an Emergency Care Unit, a General Surgery Unit, an Oncology Unit, a Pediatrics Unit, and a Pharmacy Unit, among others. Further, each of these units requires associated staff members and equipment to provide care for patients of the hospital.

Hospitals generally use a nurse call system to alert staff of varying needs of support in the hospital. Typically, a nurse call system is implemented over a hospital's internal network and utilized to update staff as to needed support within the care units of the hospital. The needed support is generally handled by a staff member assigned to a specific location or level of support within a hospital/hospital care unit. A staff member assignment is typically done at the beginning of that staff member's shift and modified accordingly based on staffing needs and breaks.

In certain types of nurse call systems, the staff assignments are made at a central location that handles specific staff members starting/stopping their shifts and taking breaks. The central location can also be used for staff assignments to specific units within the hospital. Because staffing assignments are generally handled at a centralized location, a bottleneck occurs at certain points during the day when large numbers of staff come on and off duty. Further, the updated staff assignment is not shared within the hospital's internal network with all of the various care units and the specialized equipment within that care unit. Other arrangements of nurse call systems exist, such as those where staff assignments are made at nurses' stations within the various units in the hospital. Some hospitals may use a combination of central and nurse's station staffing assignments.

Accordingly, errors will be made in the staff assignments in that not every care unit will have the same information regarding staff assignments. Also, system use may decline among the staff because of the bottleneck created during shift changes within the hospital and the hassle associated with updating a staff assignment at each of the care units that a particular staff member may be assigned throughout the course of a work shift.

In view of the above, there is a need for a system that will update staff assignments efficiently and across all care units of a hospital and also between numerous disparate and diverse systems. Embodiments of the invention provide such a solution for hospital staff assignment and nurse call systems. These and other advantages of the invention, as well as additional inventive features, will be apparent from the description of the invention provided herein.

### BRIEF SUMMARY OF THE INVENTION

One embodiment provides an assignment system for coordinating staff members of a hospital. The assignment system includes a plurality of interface devices, a communication network, an application server, and a nurse call system. The communication network is coupled to each of the plurality of interface devices, and the plurality of interface devices capable of receiving input data and sending output data over the communication network. The application server is coupled to the communication network and configured to communicate with each of the plurality of interface devices. The nurse call system is coupled to the application server and configured to track and update one or more client devices based on data received from the application server.

Another embodiment includes a method of coordinating staff assignments in a hospital nurse call system. The hospital nurse call system interfaces with an application server that communicates with an at least one publishing device over a communication network. The method includes receiving, by an assignment interface of the application server, a staff assignment from the at least one publishing device. The method further includes parsing, by the assignment interface, the staff assignment to obtain assignment information, and storing the assignment information of the staff assignment in a call system database associated with the nurse call system. Further the method includes detecting, by the nurse call system, the stored assignment information, and notifying, by the nurse call system, a client device of the nurse call system of the staff assignment.

Yet another embodiment includes a method of coordinating staff assignments in a hospital nurse call system. The hospital nurse call system interfaces with an application server that communicates with an at least one subscribing device over a communication network. The method includes relaying, by the nurse call system, a staff assignment from a client device of the nurse call system to an assignment interface of the application server. The method further includes parsing, by the assignment interface, the staff assignment to obtain assignment information, and storing the assignment information of the staff assignment in a call system database associated with the nurse call system. Further, the method includes sending, by an assignment messenger of the assignment interface, the assignment information of the staff assignment to the at least one subscribing device.

Another embodiment includes an application server for coordinating staff members of a hospital with a nurse call system. The application server coordinates hospital staff assignments between an at least one publishing device and the nurse call system. The at least one publishing device and the application server are communicatively coupled over a hospital communication network. The application server includes an at least one processor and a computer readable memory device associated with the at least one processor. The computer readable memory device has computer executable instructions for performing the steps of receiving, by an assignment interface of the application server, a staff assignment from the at least one publishing device; parsing, by the assignment interface, the staff assignment to obtain assignment information; storing the assignment information of the staff assignment in a call system database associated with the nurse call system; and notifying the nurse call system of the stored assignment information.

### BRIEF DESCRIPTION OF THE DRAWING(S)

The accompanying drawings incorporated in and forming a part of the specification illustrate several aspects of the present invention and, together with the description, serve to explain the principles of the invention. In the drawings:

FIG. 1 is a block diagram illustrating a system for sharing and providing staff assignments in a hospital, according to an example embodiment;

FIG. 2 is a block diagram illustrating components of an interface device of FIG. 1, according to an example embodiment;

FIG. 3 is a block diagram illustrating components of a server of FIG. 1, according to an example embodiment;

FIG. 4 is a block diagram illustrating a particular embodiment of the server from FIG. 1 during the process of sharing and providing staff assignments in a hospital;

FIG. 5 is a flow diagram for publishing assignment information for a staff assignment from a publishing device to a nurse call system, according to an example embodiment;

FIG. 6 is a flow diagram for providing assignment information related to a particular staff assignment to subscriber devices, according to an example embodiment;

FIG. 7 is a flow diagram for updating a mapping of staff members, devices, locations, and levels, according to an example embodiment;

FIG. 8 is a flow diagram for updating subscriber devices with mapping information, according to an example embodiment;

FIG. 9 is a flow diagram for synchronizing assignment information related to staff assignments among publishing devices, according to an example embodiment; and

FIG. 10 is a flow diagram for pushing assignment information related to staff assignments to subscriber devices, according to an example embodiment.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

A typical hospital environment contains many care units supported by staff members employed by the hospital. Specific staff members are assigned to support the individual care units within the hospital. Even further, certain staff members will be assigned to certain area of the care unit and even assigned to particular equipment within the care unit or hospital at large.

In this manner, a staff member providing care or servicing some other need of the hospital is able to be informed in an expedient manner because that individual was pre-assigned that specific duty prior to the service needs arising. For instance, as an example, a specific staff member may be assigned to certain beds within a hospital's patient rooms. Accordingly, when a patient indicates a need for care or patient monitoring equipment indicates a need for care, the staff member assigned to that specific bed will be alerted of that need over a hospital's nurse call system.

Generally, a hospital's nurse call system is operated over the hospital's internal network. In certain situations, the network ties together the various hospital care units and the individual equipment within that care unit. Also, in order to maintain an accurate staff assignment system, assignment information must be maintained within each of the care units in general and within the associated equipment within that care unit. To accomplish this, certain staff members may need to enter a particular staff assignment in a multitude of locations, which can be burdensome on the hospital staff in general and lead to errors within the system.

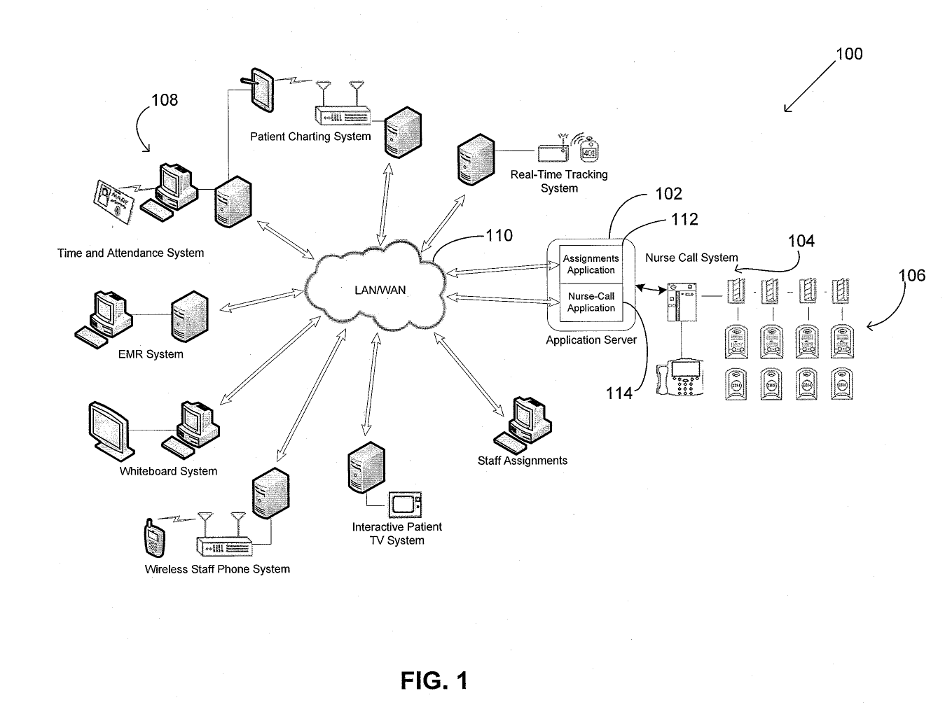

Accordingly, there is a need for a centralized system that updates staff assignments made at a single point within the network of the hospital throughout the various care units that exist within a hospital. FIG. 1 illustrates an embodiment of the invention that provides such a solution to the above described need.

FIG. 1 illustrates a block diagram of a hospital's internal network 100. The network 100 includes a nurse call application server 102 that communicates with a nurse call system 104 that includes nurse call devices 106. The nurse call devices 106 are generally devices such as corridor lights, bedside stations, bath stations, and emergency call stations.

In certain embodiments, the nurse call application server 102 connects to a plurality of interface devices 108 over a Local Area Network (LAN) or a Wide Area Network (WAN) 110 via Transmission Control Protocol of the Internet Protocol Suite (TCP/IP). The interface devices 108 are distributed throughout a hospital's various individual care units and among the hospital staff. FIG. 1 contains a non-exhaustive listing of possible interface devices 108, such as a patient charting system, a real-time tracking system, a staff assignment interface point, an interactive patient television system, a wireless staff phone system, a whiteboard system, an Electronic Medical Record (EMR) system, and a time and attendance system.

Further, in certain embodiments, the nurse call application server 102 includes a plurality of interconnected servers or a plurality of services running on an individual server. In either embodiment, the nurse call application server 102 includes an assignment application 112 and a nurse-call application 114. The assignment application 112 includes the functionality of assignment sharing between the interface devices 108 and the nurse call system 104. The nurse-call application includes functionality to interoperate the nurse call system 104 with the assignment application 112. The assignment application 112 and the nurse-call application 114 may each operate as a service running on a single server or on separate servers.

Therefore, the nurse call application server 102 bridges a communication gap between the individual interface devices 108 and the nurse call system 104. This communication is facilitated over an extensible markup language (XML) interface hosted by the nurse call application server 102 that exchanges assignment information for staff assignments and device assignments such as on/off duty or on/off break for staff assignments or wireless handset, pager, or real time location badge assignments for device assignments. Accordingly, staff and device assignments can be shared among all of the necessary interface devices 108 via the nurse call application server 102. Further, for ease of description, when the term staff assignment is used herein it is meant to include both staff assignments and device assignments.

Additionally, interface devices 108 may include cellular phones, pagers, RFID badges, or any device that is capable of being associated with an individual staff member in both name and location. In certain embodiments, an individual staff member is assigned an interface device 108, which receives calls for care for the individual staff member from the nurse call system 104. Accordingly, the interface device 108 receives updates from the nurse call system 104 that provide notice to the assigned staff member that their services are needed. For instance, the wireless staff phone system interface device 108 supports wireless phones carried by the staff. Therefore, assignment information for staff assignments related to a staff members wireless phone may be updated through the wireless staff phone system interface device 108, which updates the nurse call system 104 with the staff assignment related to the particular mobile device carried by the staff member.

Because staff assignments can be shared among the various interface devices 108, hospital staff will be able to focus on their hospital duties as opposed to constantly updating new systems as they progress through their shift. For example, by sharing information among all interface devices 108, a staff member will not have to enter their name and contact information into each interface device 108, as they access that device. Also, staff will not have to update a real time location system with their badge in order to update their location and level of care to be provided in that location. An EMR system will know what staff members are associated with a particular patient's medical charts. A patient will be able to identify the staff member assigned to provide care through an Interactive Television. Also, medical devices will have the latest staff assignments stored such that the device can quickly and efficiently inform relevant staff members of various diagnostic data and alarms.

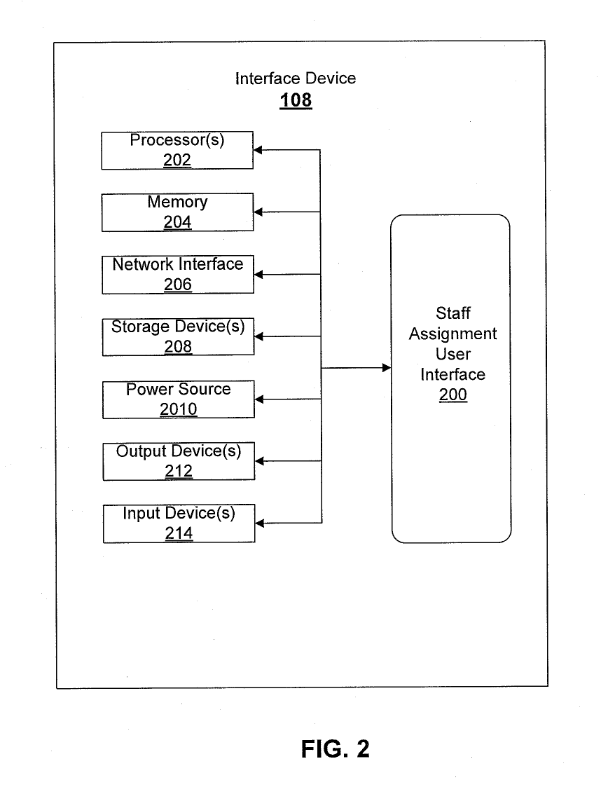

FIG. 2 illustrates a block diagram of the basic functional components for a representative interface device 108 from FIG. 1, according to one aspect of the disclosure. In general, many other embodiments of the interface device 108 may be used. In the illustrated embodiment of FIG. 2, the interface device 108 includes one or more processors 202, memory 204, a network interface 206, one or more storage devices 208, a power source 210, one or more output devices 212, and one or more input devices 214. Each of the components including the processor 202, memory 204, network interface 206, storage device 208, power source 210, the output device 212, and the input devices 214 are interconnected physically, communicatively, and/or operatively for inter-component communications.

The interface device 108 also includes a staff assignment User Interface (UI) 200. UI 200 is a network application hosted on the nurse call application server 102 (see FIG. 1) and provided over the network 110. Each of the above numerated components of the interface device 108 is capable of providing input to and receiving output from UI 200. Further, UI 200 provides viewing access of current staff and device assignments, the source of those assignments, and an assignment history of the device or staff member.

As illustrated, processor 202 is configured to implement functionality and/or process instructions for execution within the interface device 108. For example, processor 202 executes instructions stored in memory 204 or instructions store on a storage device 208. Memory 204, which may be a non-transient, computer-readable storage medium, is configured to store information within the interface device 108 during operation. In some embodiments, memory 204 includes a temporary memory, an area for information not to be maintained when the interface device 108 is turned off. Examples of such temporary memory include volatile memories such as random access memories (RAM), dynamic random access memories (DRAM), and static random access memories (SRAM). Memory 204 also maintains program instructions for execution by the processor 202.

Storage device 208 also includes one or more non-transient computer-readable storage media. The Storage device 208 is generally configured to store larger amounts of information than memory 204. The Storage device 208 may further be configured for long-term storage of information. In some examples, the Storage device 208 includes non-volatile storage elements. Non-limiting examples of non-volatile storage elements include magnetic hard discs, optical discs, floppy discs, flash memories, or forms of electrically programmable memories (EPROM) or electrically erasable and programmable (EEPROM) memories.

The interface device 108 uses network interface 206 to communicate with external devices via one or more networks, such as the network 110 of FIG. 1, one or more wireless networks, and other types of networks through which a communication with the interface device 108 may be established. Network interface 206 may be a network interface card, such as an Ethernet card, an optical transceiver, a radio frequency transceiver, or any other type of device that can send and receive information. Other non-limiting examples of network interfaces include Bluetooth®, WiFi®, and USB.

The interface device 108 includes one or more input devices 212. Input devices 212 are configured to receive input from a user or a surrounding environment of the user through tactile, audio, and/or video feedback. Non-limiting examples of input device 212 include a presence-sensitive screen, a mouse, a keyboard, a voice responsive system, video camera, microphone, optical sensor or any other type of input device. In some examples, a presence-sensitive screen includes a touch-sensitive screen.

One or more output devices 214 are also included in interface device 108. Output devices 214 are configured to provide output to a user using tactile, audio, and/or video stimuli. Output device 214 may include a display screen (part of the presence-sensitive screen), a sound card, a video graphics adapter card, or any other type of device for converting a signal into an appropriate form understandable to humans or machines. Additional examples of output device 214 include a speaker, a cathode ray tube (CRT) monitor, a liquid crystal display (LCD), or any other type of device that can generate intelligible output to a user.

The interface device 108 includes one or more power sources 210 to provide power to the device. Non-limiting examples of power source 210 include regulated power from a power network, single-use power sources, rechargeable power sources, and/or power sources developed from nickel-cadmium, lithium-ion, or other suitable material.

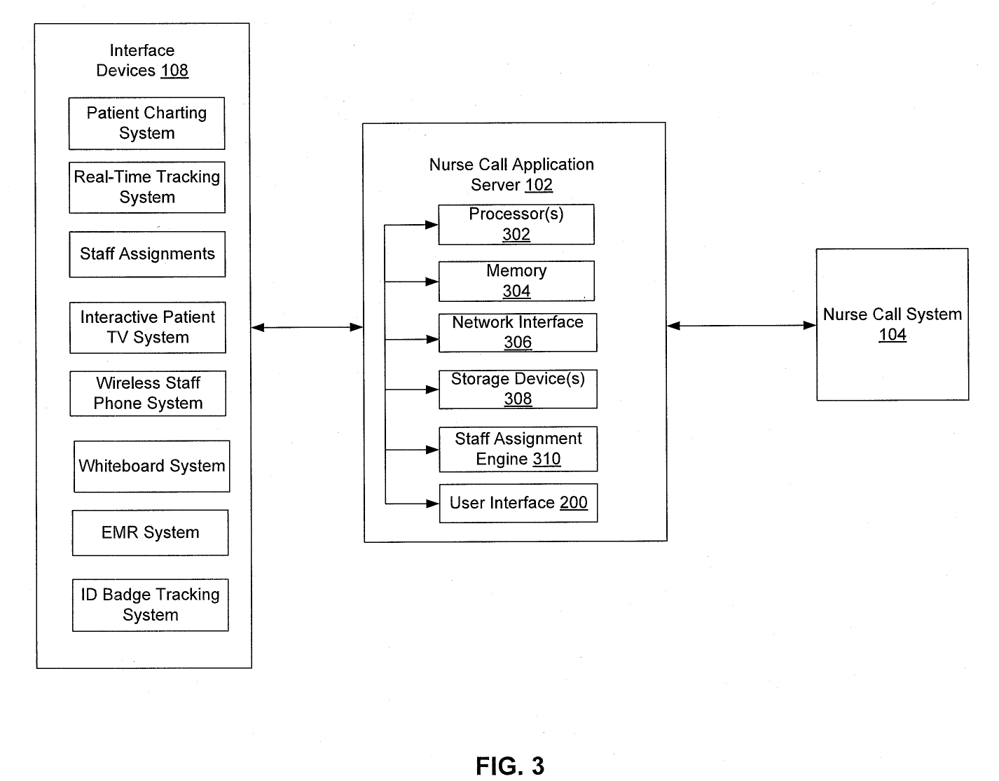

FIG. 3 provides a block diagram of the nurse call application server 102 from FIG. 1, according to one aspect of the disclosure. The nurse call application server 102 includes one or more processors 302, memory 304, a network interface 306, one or more storage devices 308, a user interface 200, and a staff assignment engine 310. In some embodiments, each of the components including the processor(s) 302, the memory 304, the network interface 306, the storage device(s) 308, the UI 200, and the staff assignment engine 310 are interconnected physically, communicatively, and/or operatively for inter-component communications.

As illustrated, processor(s) 302 are configured to implement functionality and/or process instructions for execution within server 102. For example, processors 302 execute instructions stored in memory 304 or instructions stored on storage devices 308. Memory 304, which may be a non-transient, computer-readable storage medium, is configured to store information within server 102 during operation. In some embodiments, memory 304 includes a temporary memory, i.e. an area for information not to be maintained when the server 102 is turned off. Examples of such temporary memory include volatile memories such as random access memories (RAM), dynamic random access memories (DRAM), and static random access memories (SRAM). Memory 304 also maintains program instructions for execution by the processors 302.

Storage devices 308 also include one or more non-transient computer-readable storage media. Storage devices 308 are generally configured to store larger amounts of information than memory 304. Storage devices 308 may further be configured for long-term storage of information. In some examples, storage devices 308 include non-volatile storage elements. Non-limiting examples of non-volatile storage elements include magnetic hard discs, optical discs, floppy discs, flash memories, or forms of electrically programmable memories (EPROM) or electrically erasable and programmable (EEPROM) memories.

The server 102 uses network interface 306 to communicate with external devices via one or more networks, such as the network 110 of FIG. 1. Such networks may include one or more wireless networks, wired networks, fiber optics networks, and other types of networks through which communication between the server 102 and an external device may be established. Network interface 306 may be a network interface card, such as an Ethernet card, an optical transceiver, a radio frequency transceiver, or any other type of device that can send and receive information.

As previously mentioned above regarding FIG. 2, UI 200 is a network application hosted on the nurse call application server 102 (see FIG. 1) and provided over the network 110. In this regard, UI 200 acts to provide a user access to the nurse call application server 102.

The staff assignment engine 310 includes program instructions and/or data that are executable by the server 102. The program instructions and data included in the staff assignment engine 310 include instructions to receive and transmit assignment information to and from the interface devices 108 and nurse call system 104.

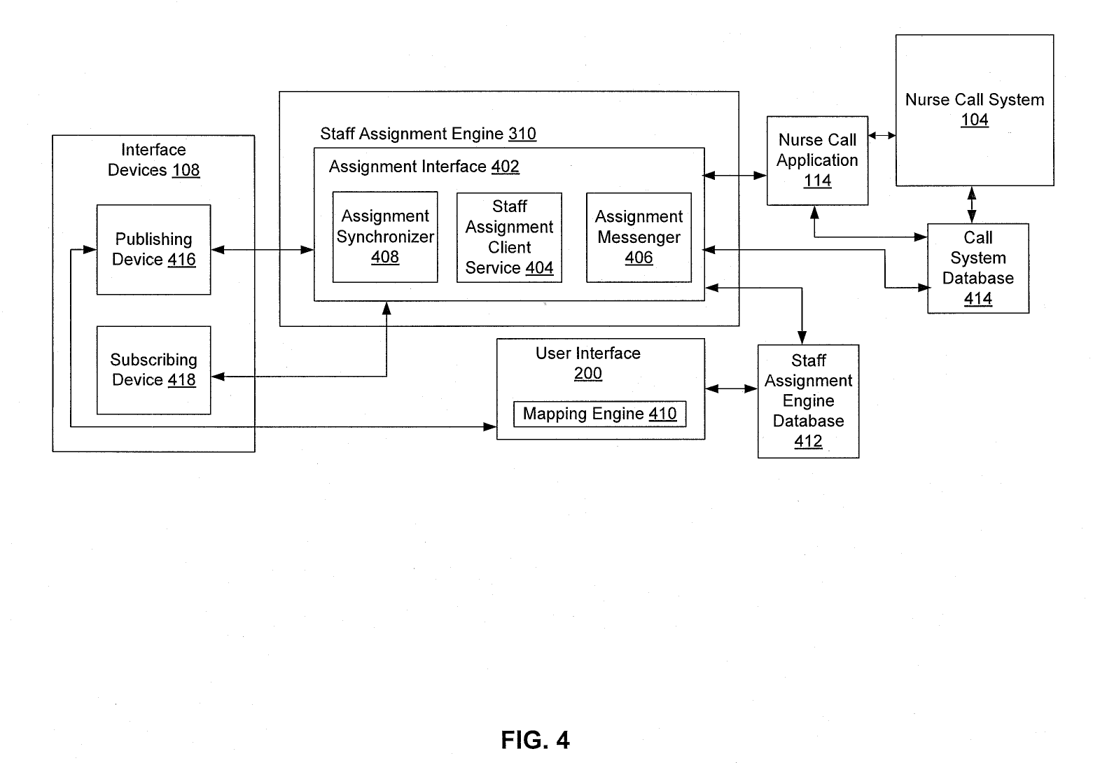

FIG. 4 illustrates a block diagram of the Staff Assignment Engine 310 of the nurse call application server 102 from FIG. 3 integrated with the interface devices 108, UI 200 from FIGS. 2 and 3, and nurse call system 104 from FIG. 1. The staff assignment engine 310 includes several functional blocks and an associated storage device 308 in the form of staff assignment engine database 412. Specifically, these functional blocks are included in an assignment interface 402.

The assignment interface 402 includes sub-blocks such as a staff assignment client service 404, an assignment messenger 406, and an assignment synchronizer 408. The assignment interface 402 exchanges messages with the interface devices 108 and is implemented as a network service and hosts a staff assignment client service 404 inside. The assignment interface 402 further includes an assignment messenger to push staff assignments to interface devices 108 that are subscribed to the assignment server 102. The assignment interface 402 also includes an assignment synchronizer 408, which synchronizes staff assignments with interface devices 108 that are configured to publish staff assignments to the nurse call application server 102.

Accordingly, the interface devices 108 are shown with two representative devices; one device set up as a publishing device 416 and another device set up as a subscribing device 418. As stated previously, interface devices 108 can comprise a multitude of device types used in a hospital environment. Each type of these devices has a different functionality and can be set up within the hospital's internal network 100 (see FIG. 1) as a publishing device, a subscribing device, or both. A publishing device, such as publishing device 416 is configured to publish staff assignments to the assignment server 102 (see FIG. 1). A subscribing device, such as subscribing device 418 is configured to subscribe to the assignment server 102 to receive the published staff assignments.

The previously mentioned assignment interface 402 acts to relay staff assignments to endpoint systems such as interface devices 108 including publishing devices 416 and subscriber devices 418. In the embodiment of the disclosure illustrated in FIG. 4, the specific entity charged with this duty is the staff assignment client service 404. Client service 404 exchanges staff assignments defined in an Application Programming Interface (API). These staff assignments are defined as Extensible Markup Language (XML) rules specifically in a Web Services Description Language (WSDL) interface description language used to describe the functionality offered by the client service 404. This WSDL interface is utilized by all interface devices 108. Accordingly, in certain embodiments, the staff assignment client service 404 may be known as a staff assignment web service 404.

Further, the assignment messenger 406 of the assignment interface 402 pushes the staff assignments to subscribing device(s) 418. When a new staff assignment is recognized in the system, the assignment messenger interfaces with database 412 to determine a list of subscribing device(s) 418 that should receive the staff assignment. The updated staff assignment will be relayed via the API on the client service 404.

Another functional block of the assignment interface 402 is the assignment synchronizer 408, which synchronizes staff assignments from the nurse call system 104 with staff assignments from all publishing device(s) 416. The assignment synchronizer 408 runs whenever the staff assignment engine 310 starts and runs again periodically thereafter. The frequency of synchronization is typically every five minutes, but could be any time that system operators desired. Ideally, the frequency would be no less than one synchronization every ten minutes and no more than one synchronization every one minute.

During synchronization, the assignment synchronizer 408 obtains a list of publishing device(s) 418 from database 412 and proceeds to query each publishing device 418 for staff assignments from that specific publishing device 418. The assignment synchronizer 408 then obtains a list of staff assignments from that specific publishing device 418, as stored in database 414 associated with the nurse call system 104 and compares the former list with the later list. Based on the comparison, the assignment synchronizer 408 will update the staff assignments stored in database 414 with the latest staff assignments from publishing device(s) 418.

The synchronization process performed by the assignment synchronizer 408 is typically enabled upon system initialization or reinitialization. This is done to ensure an accurate list of staff assignments, and therefore, acts primarily as a back up to the various updates created via the staff assignments from the staff assignment engine 310.

Furthermore, UI 200, which was discussed above while referencing FIGS. 2 and 3, is now illustrated with more detail to include a mapping engine 410. The mapping engine 410 allows a user to update staff, device, location, and level mapping within the nurse call system 104 and its associated database 414 and the nurse call application server 102 (see FIG. 1) and its associated database 412. Mapping engine 410 allows a user to update a variety of parameters associated with staff members and interface devices 108. One such parameter is whether an interface device 108 is configured as a publisher, a subscriber or both. Once this assignment is made, it is saved in the database 412. After this parameter is set in the database 412, then the staff assignment engine 310 will know what interface device 108 is associated with what functional block—either the assignment messenger 406 or the assignment synchronizer 408. Accordingly, the mapping stored in the database 412 acts to translate staff assignments from the various interface devices 108 for the staff assignment engine 310 and the nurse call system 104. This translation ensures that the correct data associated with specific staff assignments is communicated to the nurse call system 104.

Another function of the mapping engine 410 is to allow a user via the UI 200 to compare and synchronize patient bed mappings between database 412 and database 414. Accordingly, an accurate bed mapping is maintained between the nurse call system 104 and the staff assignment engine 310.

Another function of the mapping engine 408 is team mapping. This allows the user to synchronize unit teams such as an ICU unit or oncology unit, to name a few, between database 412 and database 414.

Another function of the mapping engine 408 is staff mapping and interface device mapping. This allows the user to synchronize staff lists and interface device lists between database 412 and database 414.

As an aside, while the above mapping is described as being between database 412 and database 414, database 412 actually acts more as a translator between the publishing device 416 and database 414. Specifically, synchronization is really achieved between various storage devices 208 (see FIG. 2) of the interface device 108 in the form of publishing device 416 and the call system database 414. Accordingly, the mapping described above is stored in the staff assignment engine database 412 such that database 412 is able to utilize the mapping to translate where data sent from the publishing device 416 should be sent in order to properly update the call system database 414 such that the call system 104 can interpret the staff assignment.

This translation is necessary because the various interface devices 108 may each have a different way of describing the staff, device, location, and level associated with that device, while the nurse call system 104 has only a single way of describing each staff, device, location, and level. Accordingly, a translation is needed for the nurse call system 104 to properly interpret the staff assignment data. This translation is stored as a user defined mapping in the staff assignment engine database 412.

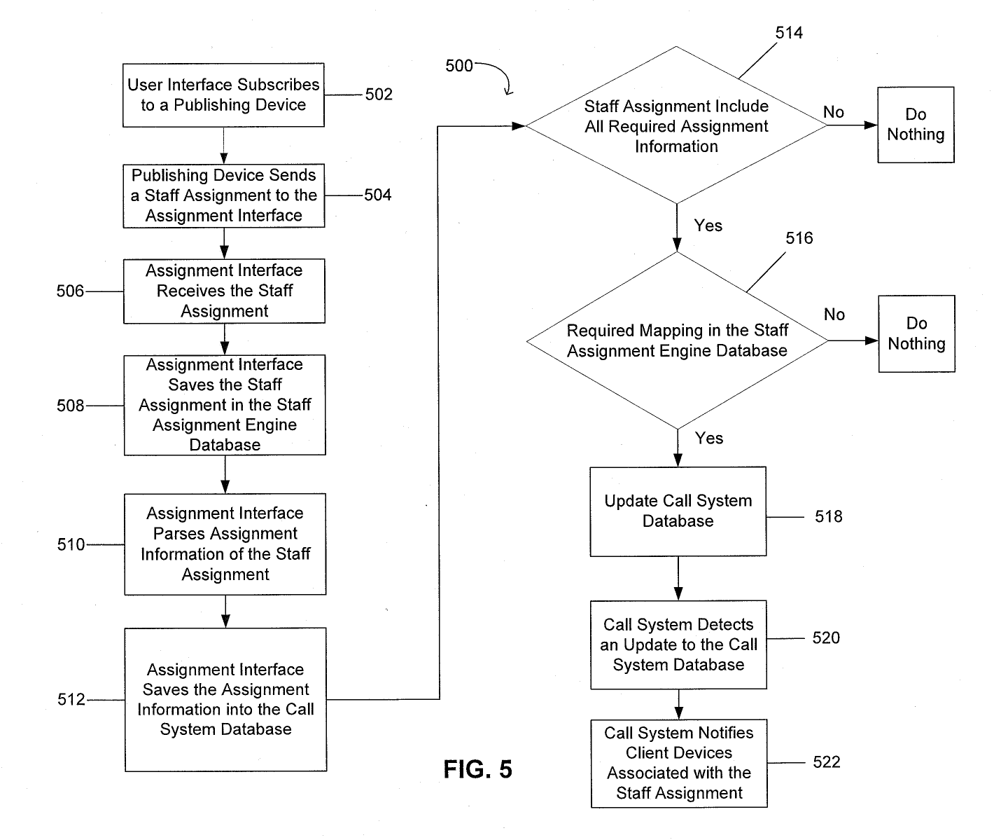

Turning now to FIGS. 5-10, various scenarios of how staff assignments are shared between interface devices 108 and the nurse call system 104 are described. FIG. 5 illustrates a method 500 of sending staff assignments from a publishing device 416. Method 500 begins with a user utilizing the UI 200 (see FIG. 4) to subscribe to a publishing device 416 at step 502. The user enters assignment information related to a staff assignment that the publishing device sends to the assignment interface 402 at step 504. At step 506, the assignment interface 402 receives the staff assignment from the publishing device 416. The assignment interface 402 saves the assignment information to the database 412 at step 508. At step 510, the assignment interface 402 parses the assignment information to obtain the assignment information including the mapping information. At step 512 the assignment interface saves the parsed information pertaining to the staff assignment into database 414. At step 514, the nurse call application 114 of the nurse call system 104 determines whether all required assignment information was provided. If all of the required assignment information was not provided, the nurse call application 114 of the nurse call system 104 does nothing. If all required information was provided, the nurse call application 114 of the nurse call system 104 proceeds to step 516. At step 516, the nurse call application 114 checks whether the required mapping information is stored in the staff assignment engine database 412 in order to interpret the staff assignment. If the required mapping is not stored, then the nurse call application 114 of the nurse call system 104 does nothing. If the required mapping is stored, then the nurse call application 114 of the nurse call system 104 updates the call system database 414 at block 518. The nurse call system 104 detects an update to database 414 at step 520, and at step 522, notifies the interface device 108 (see FIG. 1) associated with the mapping information parsed from the assignment information in step 510.

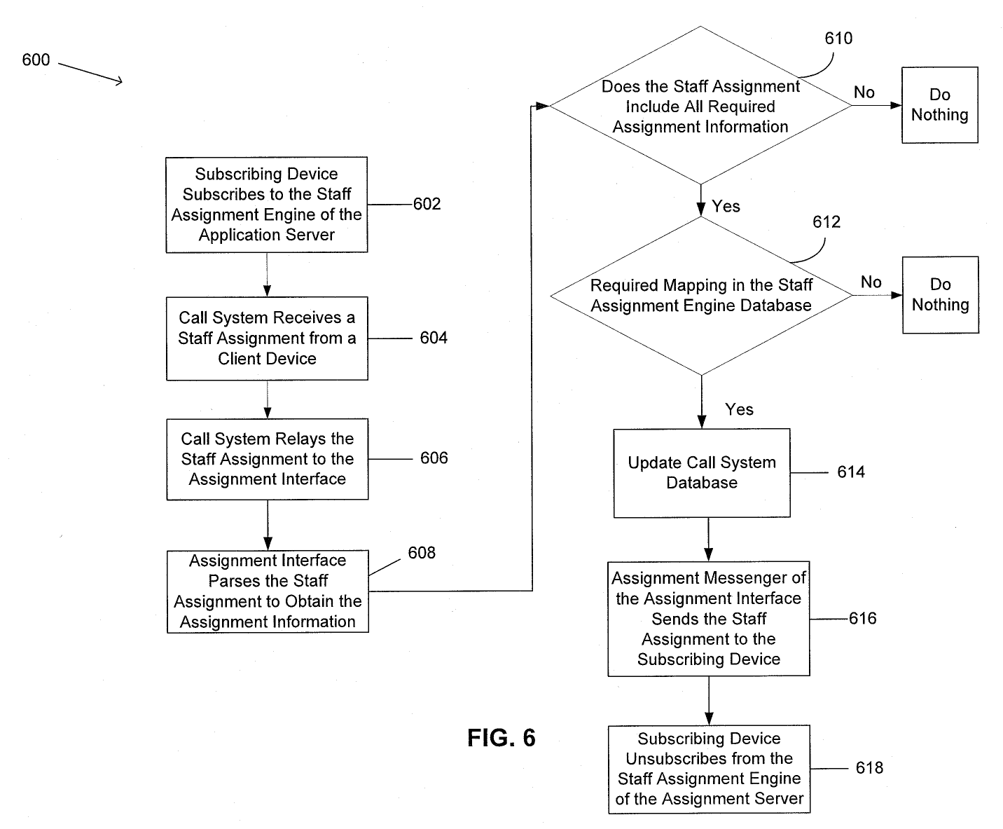

FIG. 6 illustrates a method 600 of receiving staff assignments at a subscribing device 418. At step 602, the subscribing device 418 subscribes to the staff assignment engine 310 of the nurse call application server 102 (see FIG. 1). At step 604, an interface device 108 (see FIG. 1) provides a staff assignment to the nurse call system 104. At step 606, the nurse call system 104 relays this staff assignment to the assignment interface 402. At step 608, the assignment interface 402 parses the staff assignment to obtain the assignment information associated with the staff assignment. At step 610, the assignment interface determines whether all required assignment information was provided in the staff assignment. If the required information was not provided, then the method stops. If the required assignment information was provided, then the at block 612 the method checks whether the required mapping is stored in the staff assignment engine database 412 in order to interpret the staff assignment. If the required mapping is not stored, then the method stops. If the required mapping is stored, then at block 614 the call system database 414 is updated with the staff assignment, and assignment messenger 406 of the assignment interface 402 sends the staff assignment to the subscribing device 418 at step 616. At step 618, the subscribing device unsubscribes from the staff assignment engine 310 of the assignment server 102.

A list of staff assignments defined in the API associated with FIGS. 5 and 6 are Set Staff to Device Assignment Change, Set Staff to Location Assignment Change, Set Device to Location Assignment Change, Set Staff On Duty Status, Set Staff On Break Status, Set Device On Duty Status, and Set Device Break Status. Each of these staff assignments contains common assignment information and individual assignment information. The common assignment information for each are a source of the staff assignment, an identifier for the staff assignment, a time stamp for the staff assignment, and an event action parameter. The event action parameter is the name of the staff assignment being sent such as “Set Staff On Duty Status.” The identifier of the staff assignment allows the specific staff assignment to be tracked in the system. The individual assignment information will be described below in relation to the individual staff assignment descriptions.

Regarding the Set Staff to Device Assignment Change, this staff assignment assigns or unassigns a device such as interface device 108 (see FIG. 1) to/from a staff member. Assignment information required for this staff assignment is the staff member and an associated device.

Regarding the Set Staff to Location Assignment Change, this staff assignment assigns to a staff member a location such as a hospital department like the ICU or a bed in a particular hospital department. This staff assignment further specifies a specific care level such as primary care provider or secondary care provider for the staff member. Accordingly, required assignment information to be included in this staff assignment is a staff member and a location. Optionally, the staff assignment can specify a level of care. Also optionally, this staff assignment can specify a response team such as a nursing care team or an environmental team associated with that particular location. Further optional assignment information is a particular patient in need of care, a start time for this staff assignment, and a stop time for this assignment.

Further, because the assignment information for this staff assignment may also optionally specify a start and end time for the assignment, a pre-assignment can be made by specifying the time at which this assignment is made. Therefore, this staff assignment can be entered prior to the staff member starting their shift for the day, and the staff assignment will be implemented once the associated staff member comes on duty.

Regarding the Set Device to Location Assignment Change, this staff assignment assigns a device to a location such as a hospital department like the ICU or a bed in a particular hospital department. This staff assignment further specifies a specific care level such as primary care or secondary care for the device. Accordingly, required assignment information to be included in this staff assignment is a device, a location, and a level of care. Optionally, this staff assignment can specify a particular patient in need of care, a start time for this staff assignment, and a stop time for this assignment.

Further, the assignment information for this staff assignment may also optionally specify a start and end time for the assignment. However, as opposed to the counterpart staff assignment related to assigning a staff member location, this staff assignment does not utilize pre-assignments because devices are always online. Accordingly, this staff assignment will be shared immediately, as opposed to when a staff member comes on duty.

Regarding the Set Staff On Duty Status, this staff assignment sets a staff member either on or off duty, and can be optionally extended to setting a team of staff members on or off duty. Furthermore, as previously discussed pre-assignments may be made for certain staff members, and these assignments should only be shared once that particular staff member is on duty. Therefore, once this staff assignment is made, any stored pre-assignments will be shared.

Additionally, an off duty assignment will automatically trigger sharing of unassign events for any staff to device, staff to location, and device to location mappings that were active for the particular staff member.

The Set Staff On Duty Status staff assignment includes certain required assignment information to be provided prior to sharing the staff assignment. The required assignment information is a status such as on or off duty and an associated staff member. Optional assignment information is team information such as a whole staff team coming on or off duty.

Regarding the Set Staff On Break Status, this staff assignment sets a staff member either on or off break, and can be optionally extended to specifying a covering staff member while the primary staff member is on break. Because being on break in temporary, staff assignments related to the break are shared.

The Set Staff On Break Status staff assignment includes certain required assignment information to be provided prior to sharing. The required assignment information is a status such as on or off break, and an associated staff member. Optional assignment information is a staff member that will cover for the staff member on break.

Regarding the Set Device On Duty Status, this staff assignment sets a device on or off duty, and optionally for a team. Also, only staff assignments associated with an on duty device will be shared. Accordingly, setting a device on duty initiates sharing of any pre-assignments. Further, an off duty message from this staff assignment triggers sharing of unassign events for any device to location assignments that were active for this particular device.

The Set Device On Duty Status staff assignment includes certain required assignment information to be provided prior to sharing. The required assignment information is an event action such as on or off duty and a particular device associated coming on or off duty. Optional assignment information includes a team associated with the device coming on or off duty.

Regarding the Set Device On Break Status, this staff assignment sets a device on or off break, and optionally provides for a covering device while the primary device in on break. In the situation where a covering device is specified, once the primary device comes back on duty from a break the covering device is automatically removed. This staff assignment associated with a device on break will be shared, as break status is only temporary and the device is still on duty.

The Set Device On Break Status staff assignment includes certain required assignment information to be provided prior to sharing. The required assignment information is a status such as on or off break and a specific device associated that is going on or off break. Optionally, assignment information pertaining to a covering device may be specified.

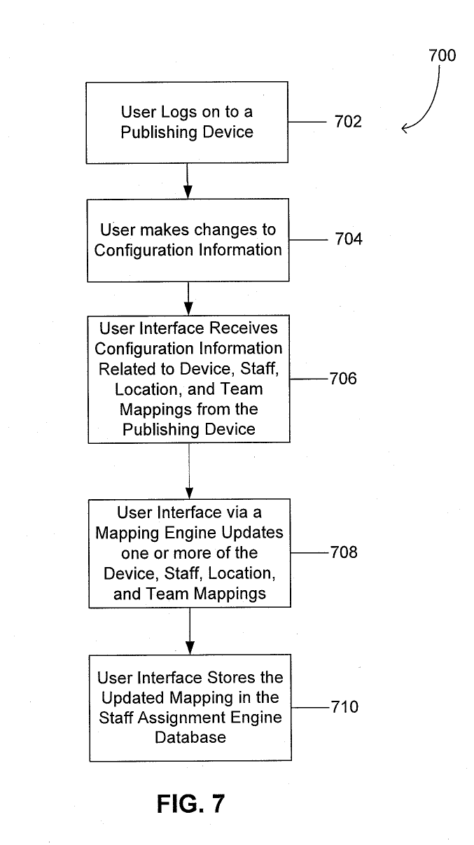

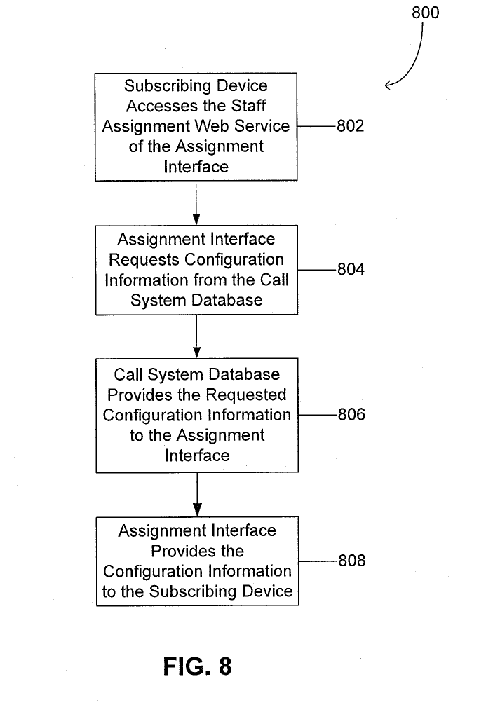

FIGS. 7 and 8 illustrate situations where a publishing device 416 loads configuration information into database 412 and a subscribing device 418 receives configuration information from database 414, respectively. In certain embodiments, this is done to alter device, staff, location, level, and team mappings stored in the database 412 and 414 (see FIG. 4). This configuration data is provided from staff assignments defined in the API.

FIG. 7 illustrates a method 700 where a publishing device 416 updates configuration information associated with locations, teams, devices, or staff members in order to alter mapping information via the mapping engine 410 of the UI 200. At step 702, a user logs on to the publishing device 416. At step 704, the user updates configuration information at the publishing device 416 via the UI 200. At block 706, the UI 200 receives configuration information from the publishing device 416. At step 708, the mapping engine 410 updates the configuration information from the publishing device 416. At step 710, the UI 200 stores this updated mapping in the staff assignment engine database 412.

FIG. 8 illustrates a method 800 where configuration information is passed to a subscribing device 418. A subscribing device 418 will query this configuration information in order to have an up to date listing of staff assignments at the subscribing device 418. At step 802, the subscribing device 418 accesses the staff assignment engine 310 (see FIG. 4) by sending staff assignments defined in the API to the staff assignment client service 404 of the assignment interface 402. At step 804, the assignment interface 402 requests the configuration information from the call system database 414. At step 806, database 414 provides the requested configuration information to the assignment interface 402. At step 808, the assignment interface 402 provides the configuration information to the subscribing device 418.

A list of staff assignments or, by another name, system requests defined in the API associated with FIGS. 7 and 8 are Get All Staff, Get All Locations, Get All Devices, and Get All Teams. Specifically, these requests specify a source of the request, an identifier for the request, a timestamp for the request, and an event action for the request. Optionally, the request can further specify a destination for the request. In return, a list of all staff, or locations, or devices, or teams is provided to the requesting subscribing device 418 or from the requested publishing device 416.

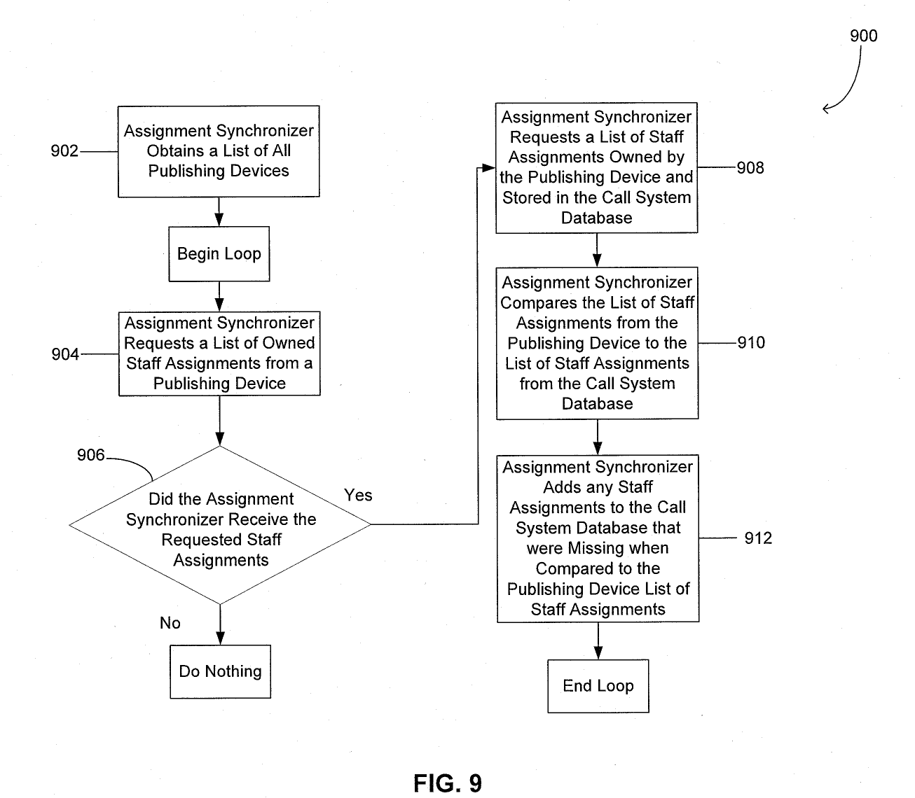

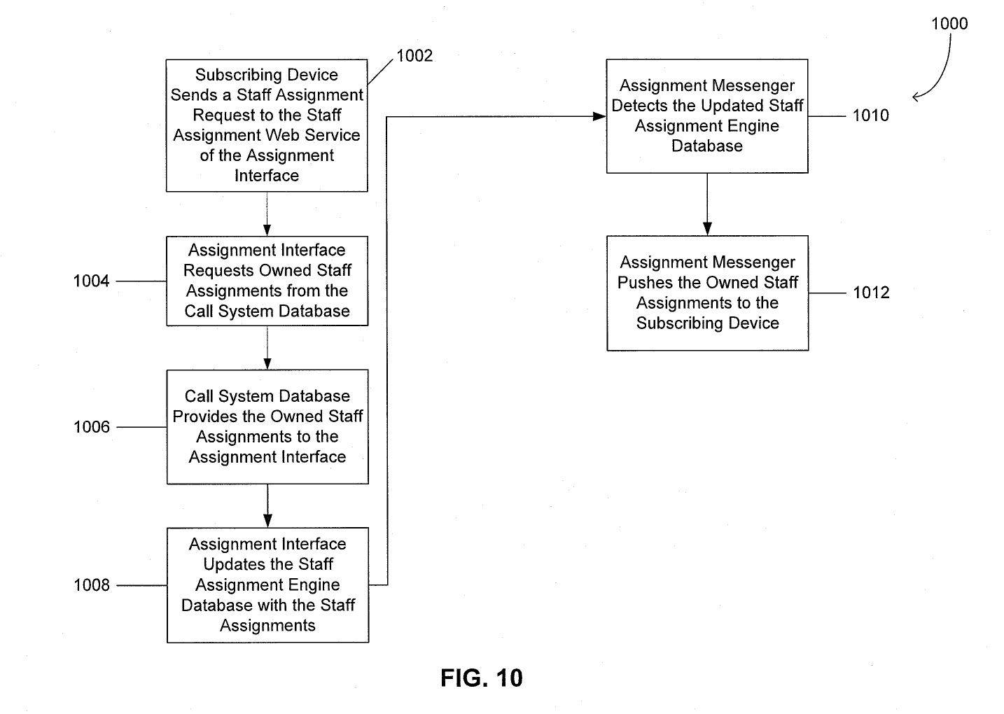

FIGS. 9 and 10 illustrate the exchange of operation information requests in order to maintain an accurate list of owned staff assignments at each publishing device 416 or subscribing device 418. FIG. 9 illustrates a method 900 by which an accurate listing of owned staff assignments of a publishing device 416 is maintained. At step 902, the assignment synchronizer 408 (see FIG. 4) obtains a list of all publishing device(s) 416 from the staff assignment engine database 412 and loops each publishing device 416 through the following four steps. At step 904, the assignment synchronizer 408 requests a list of owned staff assignments from a publishing device 416. Next, question block 906 checks to see if the assignment synchronizer 408 received the requested staff assignments from the publishing device 416. If the staff assignments were received, the assignment synchronizer 408 requests a list of staff assignments owned by the publishing device 416 from the call system database 414, at step 908. At step 910, the assignment synchronizer 408 compares the list of owned staff assignments from the publishing device 416 to the list of owned staff assignments from the call system database 414. The assignment synchronizer 408 adds any staff assignments to the call system database 414 that were missing when compared to the list from the publishing device 416.

FIG. 10 illustrates a method 1000 for providing staff assignments to a subscribing device 418. At step 1002, a subscribing device 418 (see FIG. 4) sends a staff assignment request of the API via the client service 404. At step 1004, the assignment interface 402 requests owned staff assignments from the call system database 414. At step 1006, the call system database 414 provides the owned staff assignments to the assignment interface 402. At step 1008, the assignment interface 402 loads the staff assignments received in the previous step 1006 into the staff assignment engine database 412. At step 1010, the assignment messenger 406 detects the update to the staff assignment engine database 412. At step 1012, the assignment messenger pushes the owned staff assignments to the subscribing device 418.

The staff assignment requests defined in the API related to FIGS. 9 and 10 are Get All Owned Staff to Device Assignments, Get All Owned Staff to Location Assignments, Get All Owned Device to Location Assignments, Get All Owned Staff On Duty, Get All Owned Staff On Break, Get All Owned Devices On Duty, and Get All Owned Devices On Break. The only required assignment information pertaining to each of these staff assignment requests is the source of the request and a message identifier that specifies the specific staff assignment request. Optionally, a destination can be specified as well.

The Get All Owned Staff to Device Assignments staff assignment request will provide a list of all staff members assigned to interface device 108 (see FIG. 4) requesting this staff assignment. The assignment synchronizer utilizes this staff assignment request to synchronize staff assignments published by a publishing device 416 with a list of staff assignments stored at the call system database 414. This ensures that an accurate list of published device to staff member assignments is maintained between the publishing device 416 and the call system database 414. The subscribing device 418 utilizes this staff assignment request to ensure that its list of assignments in its storage device 208 (see FIG. 2) matches the list on the call system database 414.

The Get All Owned Staff to Location Assignments staff assignment request will provide a list of all staff members assigned to hospital location. The assignment synchronizer utilizes this staff assignment request to synchronize staff assignments published by a publishing device 416 with a list of staff assignments stored at the call system database 414. This ensures that an accurate list of published location to staff member assignments is maintained between publishing device 416 and the call system database 414. The subscribing device 418 utilizes this staff assignment request to ensure that its list of assignments in its storage device 208 (see FIG. 2) matches the list on the call system database 414.

The Get All Owned Staff to Location Assignments staff assignment request will provide a list of all staff members assigned to a hospital location. The assignment synchronizer utilizes this staff assignment request to synchronize staff assignments published by a publishing device 416 with a list of staff assignments stored at the call system database 414. This ensures that an accurate list of published location to staff member assignments is maintained between publishing device 416 and the call system database 414. The subscribing device 418 utilizes this staff assignment request to ensure that its list of assignments in its storage device 208 (see FIG. 2) matches the list on the call system database 414.

The Get All Owned Device to Location Assignments staff assignment request will provide a list of all hospital locations assigned to a device. The assignment synchronizer utilizes this staff assignment request to synchronize staff assignments published by a publishing device 416 with a list of staff assignments stored at the call system database 414. This ensures that an accurate list of published device to location assignments is maintained between publishing device 416 and the call system database 414. The subscribing device 418 utilizes this staff assignment request to ensure that its list of assignments in its storage device 208 (see FIG. 2) matches the list on the call system database 414.

The Get All Owned Staff On Duty staff assignment request will provide a list of all on duty staff members assigned to a particular interface device 108 (see FIG. 4). The assignment synchronizer utilizes this staff assignment request to synchronize staff assignments published by a publishing device 416 with a list of staff assignments stored at the call system database 414. This ensures that an accurate list of published on duty staff member assignments is maintained between publishing device 416 and the call system database 414. The subscribing device 418 utilizes this staff assignment request to ensure that its list of assignments in its storage device 208 (see FIG. 2) matches the list on the call system database 414.

The Get All Owned Staff On Break staff assignment request will provide a list of all on break staff members assigned to a particular interface device 108 (see FIG. 4). The assignment synchronizer utilizes this staff assignment request to synchronize staff assignments published by a publishing device 416 with a list of staff assignments stored at the call system database 414. This ensures that an accurate list of on-break staff member assignments is maintained between publishing device 416 and the call system database 414. The subscribing device 418 utilizes this staff assignment request to ensure that its list of assignments in its storage device 208 (see FIG. 2) matches the list on the call system database 414.

The Get All Owned Devices On Duty staff assignment request will provide a list of all interface devices 108 (see FIG. 1) assigned to a staff member and on duty at the time that the staff assignment is requested. The assignment synchronizer utilizes this staff assignment request to synchronize staff assignments published by a publishing device 416 with a list of staff assignments stored at the call system database 414. This ensures that an accurate list of on-break staff member assignments is maintained between publishing device 416 and the call system database 414. The subscribing device 418 utilizes this staff assignment request to ensure that its list of assignments in its storage device 208 (see FIG. 2) matches the list on the call system database 414.

The Get All Owned Devices On Break staff assignment request will provide a list of all interface devices 108 (see FIG. 1) assigned to a staff member and on break at the time that the staff assignment is requested. The assignment synchronizer utilizes this staff assignment request to synchronize staff assignments published by a publishing device 416 with a list of staff assignments stored at the call system database 414. This ensures that an accurate list of on-break staff member assignments is maintained between publishing device 416 and the call system database 414. The subscribing device 418 utilizes this staff assignment request to ensure that its list of assignments in its storage device 208 (see FIG. 2) matches the list on the call system database 414.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An assignment system for coordinating staff members of a hospital, the assignment system comprising:
a plurality of interface devices;
a communication network coupled to each of the plurality of interface devices, the plurality of interface devices capable of receiving input data and sending output data over the communication network;
an application server coupled to the communication network, the application server is configured to communicate with each of the plurality of interface devices; and
a nurse call system coupled to the application server and configured to track and update one or more client devices based on data received from the application server.

2. The assignment system of claim 1, further comprising:
a database coupled to the application server and configured to store data received at the application server; and
a call system database coupled to the nurse call system and configured to store data received at the nurse call system.

3. The assignment system of claim 2, wherein the application server comprises:
a staff assignment engine coupled to the communication network and configured to communicate with each of the plurality of interface devices and the nurse call system, the staff assignment engine is configured to relay output data and input data between the plurality of interface devices and the nurse call system;
wherein the staff assignment engine comprises:
an assignment interface, the assignment interface is configured to provide an interface between the plurality of interface devices and the nurse call system.

4. The assignment system of claim 3, wherein the application server further comprises a user interface accessed on an individual interface device.

5. The assignment system of claim 4, wherein the user interface is hosted on the assignment server.

6. The assignment system of claim 3, wherein the assignment interface of the staff assignment engine comprises:
a staff assignment client service, the staff assignment client service provides a network connection between the assignment interface and the plurality of interface devices, the staff assignment client service is configured to exchange staff assignments with the plurality of interface devices, the staff assignments comprise assignment information describing a relationship between the staff members of the hospital, the plurality of interface devices, and a location within the hospital; and
an assignment messenger, the assignment messenger is configured to push staff assignments to the plurality of interface devices after receiving notification of a staff assignment change from the nurse call system.

7. The assignment system of claim 6, wherein the assignment interface further comprises an assignment synchronizer, the assignment synchronizer synchronizes the staff assignments in the nurse call system with the staff assignments exchanged over the staff assignment client service.

8. The assignment system of claim 3, wherein the user interface comprises a mapping engine, the mapping engine is configured to update a mapping of the staff members to the plurality of interface devices, a mapping of the staff members to locations within the hospital, and a mapping of the plurality of interface devices to locations within the hospital.

9. The assignment system of claim 8, wherein the mapping of the staff members to the plurality of interface devices, the mapping of the staff members to the locations within the hospital, and the mapping of the plurality of interface devices to locations within the hospital are user defined and manually entered over the user interface.

10. The assignment system of claim 7, wherein a first subset of the plurality of interface devices are configured as publishing devices and a second subset of the plurality of interface devices are configured as subscribing devices.

11. The assignment system of claim 10, wherein the publishing devices are configured to provide the staff assignments to the staff assignment client service of the assignment interface.

12. The assignment system of claim 10, wherein the subscribing devices are configured to receive the staff assignments from the assignment messenger of the assignment interface.

13. The assignment system of claim 10, wherein the assignment synchronizer synchronizes the staff assignments in the nurse call system with the staff assignments from the publishing devices.

14. The assignment system of claim 1, wherein the nurse call system is configured to update staff assignments.

15. The assignment system of claim 11, wherein the staff assignments are determined by the output data from the plurality of interface devices.

16. A method of coordinating staff assignments in a hospital nurse call system, the hospital nurse call system interfaces with an application server that communicates with an at least one publishing device over a communication network, the method comprising:
receiving, by an assignment interface, a staff assignment from the at least one publishing device;
parsing, by the assignment interface, the staff assignment to obtain assignment information;
storing the assignment information of the staff assignment in a call system database associated with the nurse call system;
detecting, by the nurse call system, the stored assignment information; and
notifying, by the nurse call system, a client device of the nurse call system of the staff assignment.

17. The method of claim 13, further comprising subscribing, by a user interface hosted on the application server, to the at least one publishing device, and
wherein the step of receiving comprises a client service of the assignment interface receiving the staff assignment from the at least one publishing device.

18. The method of claim 14, wherein the staff assignment is programmed in an Extensible Markup Language (XML) and communicated between the at least one publishing device and the assignment interface by a defined application programming interface (API).

19. The method of claim 18, further comprising determining whether the assignment information of the staff assignment includes all required assignment information for the staff assignment as defined by the API.

20. The method of claim 16, wherein the at least one publishing device is a plurality of publishing devices and the method further comprises synchronizing, by an assignment synchronizer of the application server, the staff assignment with the plurality of publishing devices.

21. The method of claim 16, further comprising saving the assignment information to an application server database after receiving the assignment information from the at least one publishing device.

22. The method of claim 16, wherein the staff assignment assigns a hospital staff member to a device based on assignment information including the hospital staff member and the device.

23. The method of claim 16, wherein the staff assignment assigns a hospital staff member to a location within a hospital and the assignment information includes the hospital staff member and the location within the hospital.

24. The method of claim 16, wherein the staff assignment assigns a device to a location within a hospital, the assignment information includes the device and the location within the hospital.

25. The method of claim 16, wherein the staff assignment assigns a staff on duty status, the staff on duty status indicates whether a hospital staff member is on or off duty, the assignment information associated with the staff on duty status is the hospital staff member and an on duty status.

26. The method of claim 16, wherein the staff assignment assigns a staff break status, the staff break status indicates an on or off break status of a hospital staff member, the assignment information associated with the staff break status is the hospital staff member and the staff break status.

27. The method of claim 26, wherein the assignment information associated with the staff break status further includes a covering staff member.

28. An application server for coordinating staff members of a hospital with a nurse call system, the application server coordinates hospital staff assignments between an at least one publishing device and the nurse call system, the at least one publishing device and the application server are communicatively coupled over a hospital communication network, the application server comprises:
an at least one processor; and
a computer readable memory device associated with the at least one processor, the computer readable memory device having computer executable instructions for performing the steps of:
receiving, by an assignment interface of the application server, a staff assignment from the at least one publishing device;
parsing, by the assignment interface, the staff assignment to obtain assignment information; and
storing the assignment information of the staff assignment in a call system database associated with the nurse call system.

29. The application server of claim 28, wherein the computer readable memory device has executable instructions for performing the further step of:
subscribing, by a user interface hosted on the application server, to the at least one publishing device, and
wherein the step of receiving comprises a client service of the assignment interface receiving the staff assignment from the at least one publishing device

30. The application server of claim 28, wherein the computer readable memory device has executable instructions for performing the further step of:
saving the assignment information to an application server database after receiving the assignment information from the at least one publishing device.

31. A method of coordinating staff assignments in a hospital nurse call system, the hospital nurse call system interfaces with an application server that communicates with an at least one subscribing device over a communication network, the method comprising:
relaying, by the nurse call system, a staff assignment from a client device of the nurse call system to an assignment interface of the application server;
parsing, by the assignment interface, the staff assignment to obtain assignment information; and
sending, by an assignment messenger of the assignment interface, the assignment information of the staff assignment to the at least one subscribing device.

32. The method of claim 31, further comprising subscribing by the at least one subscribing device to the application server.

33. The method of claim 31, further comprising determining whether the assignment information of the staff assignment includes all required assignment information for the staff assignment.

34. The method of claim 31, wherein the staff assignment assigns a hospital staff member to a device based on assignment information including the hospital staff member and the device.

35. The method of claim 31, wherein the staff assignment assigns a hospital staff member to a location within a hospital and the assignment information includes the hospital staff member and the location within the hospital.

36. The method of claim 31, wherein the staff assignment assigns a device to a location within a hospital, the assignment information includes the device and the location within the hospital.

37. The method of claim 31, wherein the staff assignment assigns a staff on duty status, the staff on duty status indicates whether a hospital staff member is on or off duty, the assignment information associated with the staff on duty status is the hospital staff member and an on duty status.

38. The method of claim 31, wherein the staff assignment assigns a staff break status, the staff break status indicates an on or off break status of a hospital staff member, the assignment information associated with the staff break status is the hospital staff member and the staff break status.

39. The method of claim 38, wherein the assignment information associated with the staff break status further includes a covering staff member.
